(19) United States
(12) Patent Application Publication
(10) Pub. No.: US 2021/0337821 A1
(43) Pub. Date: Nov. 4, 2021

(54) LAURIN-BASED HARD BUTTER COMPOSITION AND CHOCOLATE-LIKE FOOD CONTAINING THE SAME

(71) Applicant: FUJI OIL HOLDINGS INC., Osaka (JP)

(72) Inventors: Akiyuki ISHIWATA, Osaka (JP); Masamitsu KURIYAMA, Osaka (JP); Siau Leng Li, Singapore (SG)

(73) Assignee: FUJI OIL HOLDINGS INC., Osaka (JP)

(21) Appl. No.: 17/279,578

(22) PCT Filed: Sep. 26, 2019
(86) PCT No.: PCT/JP2019/038035

§ 371 Date: Mar. 24, 2021

(30) Foreign Application Priority Data
Sep. 28, 2018 (JP) 2018-185092

(51) Int. Cl. A23D 9/00; A23G 1/36

(52) U.S. Cl. CPC A23D 9/00; A23V 2002/00; A23G 1/36

(57) ABSTRACT

The present invention addresses the problem of blending cocoa butter into a non-tempered type chocolate containing a laurin-based hard butter and thus providing a chocolate-like food having good taste and flavor and high bloom resistance. A laurin-based hard butter composition that contains random transesterified fats or oils having an appropriately controlled fatty acids composition is provided.

### TECHNICAL FIELD

The present invention relates to a laurin-based hard butter composition and a chocolate-like food containing the same.

### BACKGROUND ART

Hard butters, which are widely used as a substitute for cocoa butter, are roughly classified into tempered type hard butters for which a temperature control operation is performed during solidification and molding, and non-tempered type hard butters for which a temperature control operation is not performed. Tempered type hard butter contains a large amount of SUS type triglycerides (S: saturated fatty acids having 16 to 18 carbon atoms, U: monounsaturated fatty acids having 18 carbon atoms) contained in cocoa butter, and has similar physical properties to those of cocoa butter. For this reason, although it has high compatibility with cocoa butter, and a texture similar to that of cocoa butter can be obtained, since strict temperature control is required for a tempering operation, it is desired to omit this operation.

Non-tempered type hard butters are not required to be subjected to a complicated tempering operation, and thus can be suitably used for various combination food products obtained by combining chocolate with bread or Western confectionery.

Among non-tempered type hard butters, trans acid type hard butters obtained by hydrogenating liquid oils such as soybean oil and rapeseed oil have been widely used because of their favorable melting sensation in the mouth and high compatibility with cocoa butter. However, in recent years, the risk of trans fatty acids to health has become clear, and low trans fatty acid type hard butters not containing trans fatty acids have come to be desired.

Patent Literature 1 to Patent Literature 5 disclose laurin-based hard butter containing a low content of trans acids and formed using laurin-based fats and oils.

### CITATION LIST

### Patent Literature

### [Patent Literature 1]

Japanese Patent Laid-Open No. 2008-182961

### [Patent Literature 2] Japanese Patent Laid-Open No. 2010-142152

### [Patent Literature 3]

Japanese Patent Laid-Open No. 2010-142153

### [Patent Literature 4]

Japanese Patent Laid-Open No. 2011-115075

### [Patent Literature 5]

Japanese Patent Laid-Open No. 2016-116486

### SUMMARY OF INVENTION

### Technical Problem

The inventors of the present invention have considered improving a quality and functionality of laurin-based hard butter. Although Patent Literature 1 to Patent Literature 5, which are chocolate-like foods formed using laurin-based hard butter, have a relatively good melting sensation in the mouth, it was thought that it was necessary to further improve the quality regarding a limitation on a formulation amount of cocoa butter, bloom resistance, and a poor melting sensation in the mouth.

In recognition of such related art, an objective of the present invention is to provide a chocolate-like food having favorable texture, flavor, and bloom resistance by blending cocoa butter into non-tempered type chocolate containing laurin-based hard butter.

### Solution to Problem

As a result of intensive studies to achieve the above-mentioned objective, the inventors of the present invention have found that a laurin-based hard butter composition, which contains random transesterified fats and oils prepared with an appropriate fatty acids composition, is effective for the above-mentioned objective, and therefore have completed the present invention.

That is, the present invention is as follows.

(1) A laurin-based hard butter composition including: 40 to 97 mass % of fats and oils A; and 3 to 60 mass % of fats and oils B,

in which a mass ratio of the fats and oils B to the fats and oils A (fats and oils B/fats and oils A) is 0.03 to 0.6, and the fats and oils A and the fats and oils B are the following fats or oils,

the fats and oils A are non-transesterified laurin-based fats and oils that satisfy the following conditions:
a content of lauric acid in a constituent fatty acids composition is 40 to 60 mass %,
a content of saturated fatty acids having 6 to 10 carbon atoms in the constituent fatty acids composition is 1 to 10 mass %,
a content of saturated fatty acids having 16 to 18 carbon atoms in the constituent fatty acids composition is 10 to 40 mass %,
a content of unsaturated fatty acids having 18 carbon atoms in the constituent fatty acids composition is 0.2 to 10 mass %, and
a rising melting point is 30° C. to 40° C., and

the fats and oils B are random transesterified fats and oils that satisfy the following conditions:
a content of saturated fatty acids having 6 to 14 carbon atoms in a constituent fatty acids composition is 20 to 80 mass %,
a content of saturated fatty acids having 16 to 18 carbon atoms in the constituent fatty acids composition is 15 to 60 mass %, and
a total amount of saturated fatty acids having 6 to 10 carbon atoms and unsaturated fatty acids having 18 carbon atoms in the constituent fatty acids composition is 3 to 50 mass %.
(2) The laurin-based hard butter composition according to (1), further including 0.5 to 10 mass % of fats and oils C,

in which a mass ratio of the fats and oils C to the fats and oils B (fats and oils C/fats and oils B) is 0.03 to 0.6, and the fats and oils C are fats and oils satisfying the following condition:
a content of saturated fatty acids having 16 to 22 carbon atoms in a constituent fatty acids composition is 95 mass % or more.

(3) The laurin-based hard butter composition according to (1) or (2), in which the fats and oils C are fats and oils satisfying the following conditions:
a content of saturated fatty acids having 16 to 18 carbon atoms in a constituent fatty acids composition is 95 mass % or more,
a content of saturated fatty acids having 16 carbon atoms in the constituent fatty acids composition is 20 to 80 mass %, and
a content of saturated fatty acids having 18 carbon atoms in the constituent fatty acids composition is 20 to 80 mass %.

(4) The laurin-based hard butter composition according to any one of (1) to (3), in which the fats and oils A are fats and oils satisfying the following condition:

a content of trans fatty acids in a constituent fatty acids composition is 1 mass % or less.

(5) A chocolate-like food including, in fats or oils contained in chocolate: 80 to 97 mass % of the laurin-based hard butter composition according to any one of (1) to (4); and 3 to 20 mass % of cocoa butter.

(6) A method of increasing bloom resistance of a chocolate-like food containing 3 to 20 mass % of cocoa butter, the method including blending 80 to 97 mass % of the laurin-based hard butter composition according to any one of (1) to (4) into fats or oils contained in chocolate.

### Advantageous Effects of Invention

According to the present invention, it is possible to provide a chocolate-like food having favorable bloom resistance in non-tempered type chocolate containing laurin-based hard butter.

In a preferred embodiment, it is possible to blend cocoa butter into a chocolate-like food of the present invention, and thereby a favorable texture and a favorable flavor can be obtained. In a more preferred embodiment, according to the present invention, it is possible to improve bloom resistance of a chocolate-like food containing laurin-based hard butter by 1.5 times or more.

### DESCRIPTION OF EMBODIMENTS

Hereinafter, the present invention will be described in more detail.

In the present invention, a chocolate-like food is not limited to chocolate, quasi chocolate, and chocolate-utilizing food products, which are defined by The Fair Trade Council of the National Chocolate Industry and The Fair Trade Council of Chocolate-Utilizing Food Products, and also include products that contain fats or oils as essential ingredients, which are food products obtained by processing fats or oils using cocoa mass, cocoa, cocoa butter, cocoa butter substitute, hard butter, or the like.

A laurin-based hard butter composition of the present invention contains 40 to 97 mass % of the following fats and oils A, and 3 to 60 mass % of the following fats and oils B.

The fats and oils A are non-transesterified laurin-based fats and oils that satisfy the following conditions:
a content of lauric acid in a constituent fatty acids composition is 40 to 60 mass %,
a content of saturated fatty acids having 6 to 10 carbon atoms in the constituent fatty acids composition is 1 to 10 mass %,
a content of saturated fatty acids having 16 to 18 carbon atoms in the constituent fatty acids composition is 10 to 40 mass %,
a content of unsaturated fatty acids having 18 carbon atoms in the constituent fatty acids composition is 0.2 to 10 mass %, and
a rising melting point is 30° C. to 40° C.

The fats and oils B are random transesterified fats and oils that satisfy the following conditions:
a content of saturated fatty acids having 6 to 14 carbon atoms in a constituent fatty acids composition is 20 to 80 mass %,
a content of saturated fatty acids having 16 to 18 carbon atoms in the constituent fatty acids composition is 15 to 60 mass %, and
a total amount of saturated fatty acids having 6 to 10 carbon atoms and unsaturated fatty acids having 18 carbon atoms in the constituent fatty acids composition is 3 to 50 mass %.

The laurin-based hard butter composition of the present invention preferably contains 50 to 95 mass % of the fats and oils A, and more preferably contains 60 to 95 mass % thereof.

The laurin-based hard butter composition of the present invention preferably contains 3 to 45 mass % of the fats and oils B, and more preferably contains 3 to 40 mass % thereof.

In the laurin-based hard butter composition of the present invention, a mass ratio of the fats and oils B contained to the fats and oils A contained (fats and oils B/fats and oils A) is 0.03 to 0.6, is preferably 0.04 to 0.5, and is more preferably 0.05 to 0.45.

In the laurin-based hard butter composition of the present invention, a content of saturated fatty acids having 6 to 10 carbon atoms in a constituent fatty acids composition of the fats and oils A contained is preferably 1.5 to 10 mass %, is more preferably 2 to 10 mass %, and is even more preferably 3 to 10 mass %.

In the laurin-based hard butter composition of the present invention, a content of saturated fatty acids having 16 to 18 carbon atoms in the constituent fatty acids composition of the fats and oils A contained is preferably 10 to 30 mass %, and is more preferably 10 to 25 mass %.

In the laurin-based hard butter composition of the present invention, a content of unsaturated fatty acids having 18 carbon atoms in the constituent fatty acids composition of the fats and oils A contained is preferably 0.2 to 8 mass %, and is more preferably 0.3 to 8 mass %.

In the laurin-based hard butter composition of the present invention, a content of trans fatty acids in the constituent fatty acids composition of the fats and oils A contained is preferably 1 mass % or less.

In the laurin-based hard butter composition of the present invention, as a preferred embodiment, an upper limit of a total content of saturated fatty acids having 6 to 10 carbon atoms and unsaturated fatty acids having 18 carbon atoms in a constituent fatty acids composition of the fats and oils B contained is preferably 25 mass %, is more preferably 23 mass %, and is even more preferably 20 mass %. It is desirable that the upper limit is within such a numerical value range in terms of a solidification time for chocolate.

In the laurin-based hard butter composition of the present invention, as a preferred embodiment, a lower limit of a content of saturated fatty acids having 6 to 10 carbon atoms and unsaturated fatty acids having 18 carbon atoms in a constituent fatty acids composition of the fats and oils B contained is preferably 10 mass %, is more preferably 11 mass %, and is even more preferably 12 mass %. It is desirable that the lower limit is within such a numerical value range in terms of a melting sensation of chocolate in the mouth.

In the laurin-based hard butter composition of the present invention, as a preferred embodiment, a content of saturated fatty acids having 6 to 14 carbon atoms in the constituent fatty acids composition of the fats and oils B contained is preferably 25 to 75 mass %, is more preferably 30 to 70 mass %, and is even more preferably 30 to 65 mass %.

In the laurin-based hard butter composition of the present invention, as a preferred embodiment, a content of saturated fatty acids having 16 to 18 carbon atoms in the constituent fatty acids composition of the fats and oils B contained is preferably 20 to 60 mass %, is more preferably 30 to 60 mass %, and is even more preferably 35 to 55 mass %.

In the laurin-based hard butter composition of the present invention, a case in which a mass ratio of the fats and oils B contained to the fats and oils A contained (fats and oils B/fats and oils A) is 0.03 to 0.6, is desirable because then bloom resistance can be improved. In a case where a mass ratio thereof is more than 0.6, a texture and a melting sensation in the mouth may deteriorate in some cases. In a case where a mass ratio thereof is less than 0.03, the effect of improving bloom resistance may be decreased.

The laurin-based hard butter composition of the present invention further contains 0.5 to 10 mass % of the following fats and oils C as a preferred embodiment.
A content of saturated fatty acids having 16 to 22 carbon atoms in a constituent fatty acids composition is 95 mass % or more.

The fats and oils C are preferably fats and oils satisfying the following conditions:
a content of saturated fatty acids having 16 to 18 carbon atoms in a constituent fatty acids composition is 95 mass % or more,
a content of saturated fatty acids having 16 carbon atoms in the constituent fatty acids composition is 20 to 80 mass %, and
a content of saturated fatty acids having 18 carbon atoms in the constituent fatty acids composition is 20 to 80 mass %.

In an embodiment in which the laurin-based hard butter composition of the present invention contains the fats and oils C, a mass ratio of the fats and oils C to the fats and oils B (fats and oils C/fats and oils B) is 0.03 to 0.6, is preferably 0.04 to 0.6, and is more preferably 0.05 to 0.5.

In the embodiment in which the laurin-based hard butter composition of the present invention contains the fats and oils C, a case in which a mass ratio of the fats and oils C to the fats and oils B (fats and oils C/fats and oils B) is 0.03 to 0.6 is desirable because then it is possible to obtain bloom resistance, and a solidification rate suitable for work. In a case where a mass ratio thereof is more than 0.6, a texture and a melting sensation in the mouth may deteriorate in some cases.

In the laurin-based hard butter composition of the present invention, the fats and oils A are non-transesterified laurin-based fats and oils, and as long as the above-described constitution is satisfied, fats or oils to be used are not particularly limited, and the fats or oils may be a mixture of a plurality of kinds of fats or oils. It is preferable to use one or more kinds of fats or oils selected from palm kernel oils and fats or oils processed from palm kernel oils, because then the above-described constitution can be easily prepared. Examples of fats or oils obtained by processing palm kernel oils include hardened palm kernel oils, palm kernel fractionated hardened oils, palm kernel fractionated oils, and the like. As long as such fats or oils are used and the above-described constitution is satisfied, fats or oils to be used are not particularly limited, and other laurin-based fats or oils may be used.

In the laurin-based hard butter composition of the present invention, the fats and oils B are random transesterified fats and oils, and as long as the above-described constitution is satisfied, fats or oils to be used are not particularly limited.

An embodiment in which fats and oils are obtained by randomly transesterifying fats and oils raw materials to be randomly transesterified by mixing the following fats and oils component X with the following fats and oils component Y is a preferred embodiment because then the above-described constitution can be easily prepared.

The fats and oils component X are one or more kinds of fats or oils selected from palm oils, palm kernel oils, and fats or oils processed therefrom.

The fats and oils component Y are non-laurin-based fats and oils.

Examples of palm oils, palm kernel oils, and fats or oils processed therefrom, which can be used as the fats and oils component X, include hardened palm oils, palm kernel fractionated hardened oils, palm kernel fractionated oils, and the like.

One kind of the above-mentioned fats or oils may be used alone, or one or more kinds thereof may be used in combination.

As the non-laurin-based fats and oils which can be used as the fats and oils component Y, it is possible to use hardened oils of non-laurin-based fats or oils, fractionated oils, hardened and fractionated oils, fractionated and hardened oils, transesterified oils of non-laurin-based fats or oils, or processed fats or oils of transesterified oils of non-laurin-based fats or oils.

It is preferable to use palm-based fats or oils because then the above-described constitution can be easily prepared. Palm-oil based fats or oils having a high melting point are more preferable, and examples thereof include palm stearin obtained by fractionating a palm oil.

One kind of the above-mentioned fats or oils may be used alone, or one or more kinds thereof may be used in combination.

As a method of random transesterification, a method using sodium methylate, sodium ethylate, an alkali metal such as sodium, sodium hydroxide, potassium hydroxide, or the like as a catalyst is known as a chemical method, but it is preferable to use sodium methylate from the viewpoint of a reaction temperature, a reaction time, and ease of handling. Furthermore, as an enzyme method, a method using a fat-decomposing enzyme (lipase) as a catalyst is also known, and any method may be used.

In the laurin-based hard butter composition of the present invention, regarding the fats and oils C, as long as the above-described constitution is satisfied, fats or oils to be used are not particularly limited, and the fats or oils may be a mixture of a plurality of kinds of fats or oils. From the viewpoint that an effect can be exhibited with a small amount of blending in, preferred examples thereof include extremely hardened oil of high erucic acid rapeseed oil, extremely hardened palm oil, and extremely hardened rapeseed oil, and the like.

In a chocolate-like food formed using the laurin-based hard butter composition of the present invention may contain edible fats or oils other than the above-described fats or oils as long as the effects of the present invention are not impaired.

The laurin-based hard butter composition of the present invention can be used for non-tempered type chocolate. In the present invention, the non-tempered type chocolate is chocolate manufactured without a tempering operation or a seed tempering operation using stable crystals.

A method for manufacturing a chocolate-like food formed using the laurin-based hard butter composition of the present invention can be carried out in a general manner for manufacturing chocolates. Specifically, using the laurin-based hard butter composition of the present invention as an essential ingredient, the chocolate-like food can be obtained by appropriately selecting and mixing raw materials such as sugars, cocoa mass, cocoa butter, various powdered foods such as milk powder and cocoa powder, emulsifiers, flavors, and colorants, rolling the mixture, and conching it.

In a preferred embodiment of a chocolate-like food formed using the laurin-based hard butter composition of the present invention, 80 to 97 mass % of the laurin-based hard butter composition and 3 to 20 mass % of cocoa butter are contained in fats or oils contained in chocolate.

In the present invention, in a case where the phrase “fats or oils contained in chocolate” is referred to, it means a total amount of fats or oils contained in chocolate, and also includes fats or oils in raw materials containing fats or oils (cocoa mass, cocoa powder, whole fat milk powder, and the like), in addition to fats or oils to be blended in.

### EXAMPLES

Hereinafter, the present invention will be described in more detail by illustrating examples of the present invention. In the examples, both % and part mean on a mass basis.

Chocolate was produced according to a formulation shown in Table 2 (unit/part by mass).

A content of fats or oils (cocoa butter) in a cocoa powder used was about 11 mass %, and a content of fats or oils in the chocolate was 31.65 mass %.

Compositions of a fractionated hardened oil from palm kernel oil used and an extremely hardened oil from palm oil used are as shown in Table 1. A fractionated hardened oil from palm kernel oil is obtained by curing a fractionated high melting point part of palm kernel oil.

The produced chocolate was poured into a mold at a temperature at which fats or oils were melting (50° C.), and was cooled and solidified at 10° C.

TABLE 1

| | | | | | | | | | | Upper limit of |
|---|---|---|---|---|---|---|---|---|---|---|
| | C6 | C8 | C10 | C12 | C14 | C16 | C18 | C18:1c | C18:2c | melting point |
| Fractionated | | 1.7 | 2.6 | 55.0 | 22.0 | 8.5 | 9.3 | 0.7 | 0.1 | 35.0° C. |
| hardened oil | | | | | | | | | | |
| from palm | | | | | | | | | | |
| kernel oil | | | | | | | | | | |
| Extremely | | | | 0.2 | 1.1 | 44.8 | 53.9 | | | 50° C. or |
| hardened oil | | | | | | | | | | higher |
| from palm oil | | | | | | | | | | |

TABLE 2

| | Comparative | Reference | Reference | Reference |
|---|---|---|---|---|
| | Example 1 | Example 1 | Example 2 | Example 3 |
| Sugar | 55.0 | 55.0 | 55.0 | 55.0 |
| Cocoa powder | 15.0 | 15.0 | 15.0 | 15.0 |
| Fractionated hardened oil from palm kernel | 30.0 | 28.0 | 26.5 | 20.5 |
| oil | | | | |
| Extremely hardened oil from palm oil | | 2.0 | 3.5 | 9.5 |
| Lecithin | 0.2 | 0.2 | 0.2 | 0.2 |
| Vanilla essence | 0.03 | 0.03 | 0.03 | 0.03 |
| Content in fats or oils in chocolate | | | | |
| Cocoa butter | 5.2% | 5.2% | 5.2% | 5.2% |
| Fractionated hardened oil from palm kernel | 94.8% | 88.5% | 83.7% | 64.8% |
| oil | | | | |
| Extremely hardened oil from palm oil | | 6.3% | 11.1% | 30.0% |

(Melting Sensation in Mouth)

After the cooling and solidifying, the cooled and solidified chocolate was aged at 20° C. for 1 week. Thereafter, it was tasted and evaluated according to the following evaluation criteria. The results are summarized in Table 3.

⊚: A melting sensation in the mouth was very good, and the remaining part was not felt.

Δ: Inferior to Comparative Example 1.

X: A melting sensation in the mouth was poor.

(Evaluation of Bloom Resistance)

The chocolate was allowed to stand overnight at 20° C. and stored in an incubator at a constant temperature of 15° C. to observe change over time. Table 3 summarizes the number of days that had passed from the start of the test until occurrence of bloom.

TABLE 3

| | Comparative | Reference | Reference | Reference |
|---|---|---|---|---|
| | Example 1 | Example 1 | Example 2 | Example 3 |
| Number of days | 180 | 180 | 180 | 180 |
| passed | | | | |
| Melting sensation in | ⊚ | Δ | × | × |
| mouth | | | | |

### Conclusions

In Reference Examples 1 to 3, bloom resistance could not be improved.

In Reference Examples 1 to 3, a melting sensation in the mouth deteriorated.

A target quality was to extend a melting sensation in the mouth to the same level as that of Comparative Example 1, and to extend bloom resistance to 1.5 times that in Comparative Example 1.

1.5 g of sodium methylate as a catalyst was added to 1.0 kg of fats and oils raw material prepared at a proportion shown in Table 4, and random transesterification was carried out at 80° C. for 30 minutes. Thereafter, washing with water/decolorization/deodorization was performed by general methods. Thereby, a transesterified fats and oils was obtained. Table 5 shows results of analyzing the fatty acid composition.

Fats and oils A-1 used as fats and oils A: fractionated hardened oil from palm kernel oil (rising melting point 35.0° C.)

Fats and oils C-1 used as fats and oils C: extremely hardened oil from palm oil

Table 5 shows analysis results thereof.

TABLE 4

| | Fats and oils | Fats and oils | Fats and oils | Fats and oils | Fats and oils |
|---|---|---|---|---|---|
| | B-1 | B-2 | B-3 | B-4 | B-5 |
| Iodine value of fractionated oil from palm | 50 | | | | |
| kernel oil: 7 | | | | | |
| Iodine value of hardened palm kernel oil: | | 50 | 10 | | 50 |
| 1 or less | | | | | |
| Palm oil | | | | 40 | |
| Iodine value of hardened palm oil: 1 or less | | | | 30 | |
| Iodine value of palm stearin: 31 | 40 | 50 | | | 15 |
| Iodine value of palm stearin: 11 | 10 | | | | |
| Iodine value of extremely hardened oil from | | | 90 | | |
| palm oil: 1 or less | | | | | |
| Iodine value of fractionated intermediate | | | | | 35 |
| melting point part of palm: 46 | | | | | |
| Iodine value of hardened rapeseed oil: 1 or | | | | 30 | |
| less | | | | | |

A fractionated oil from palm kernel oil is a fractionated high melting point part of palm kernel oil, a hardened palm kernel oil is an oil obtained by hardening a palm kernel oil, and palm stearin is a fractionated high melting point part of palm oil.

TABLE 5

| | B-1 | B-2 | B-3 | B-4 | B-5 | A-1 | C-1 |
|---|---|---|---|---|---|---|---|
| C6:0 | | 0.1 | | 0.3 | 0.1 | | |
| C8:0 | 0.9 | 1.4 | 0.3 | 4.3 | 1.4 | 1.7 | |
| C10:0 | 1.3 | 1.5 | 0.3 | 3.8 | 1.4 | 2.6 | |
| C12:0 | 28.0 | 23.6 | 4.9 | 33.3 | 21.9 | 55.0 | 0.2 |
| C14:0 | 11.6 | 8.8 | 2.6 | 13.0 | 8.0 | 22.0 | 1.1 |
| C16:0 | 38.4 | 36.5 | 40.1 | 7.9 | 32.0 | 8.5 | 44.8 |
| C18:0 | 3.3 | 12.9 | 51.3 | 33.7 | 14.0 | 9.3 | 53.9 |
| C18:1t | 0.0 | 0.2 | 0.0 | 0.0 | 0.0 | 0.0 | 0.0 |
| C18:1c | 13.6 | 12.3 | 0.0 | 2.5 | 17.6 | 0.7 | |
| C18:2t | 0.1 | 0.1 | 0.0 | 0.0 | 0.0 | 0.0 | 0.0 |
| C18:2c | 2.4 | 2.3 | 0.0 | 0.6 | 3.3 | 0.1 | |
| C18:3 | 0.0 | 0.0 | 0.0 | 0.0 | 0.3 | | |
| C20:0 | 0.2 | 0.3 | 0.4 | 0.6 | 0.0 | | |
| Content of saturated | 41.8 | 35.4 | 8.1 | 54.7 | 32.8 | | |
| fatty acids | | | | | | | |
| having 6 to 14 | | | | | | | |
| carbon atoms | | | | | | | |
| Content (a) of saturated | 2.2 | 3.0 | 0.6 | 8.4 | 2.9 | | |
| fatty | | | | | | | |
| acids having 6 to 10 | | | | | | | |
| carbon atoms | | | | | | | |
| Content (b) of unsaturated | 16.0 | 14.6 | 0.0 | 3.1 | 21.1 | | |
| fatty | | | | | | | |
| acids having 18 carbon | | | | | | | |
| atoms (a) + (b) | 18.2 | 17.6 | 0.6 | 11.4 | 24.0 | | |
| Content of saturated | 47.8 | 49.4 | 91.4 | 41.6 | 46.1 | | |
| fatty acids | | | | | | | |
| having 16 to 18 carbon | | | | | | | |
| atoms | | | | | | | |

Using the fats and oils B-1 to the fats and oils B-5 which were produced above for the fats and oils B, chocolates of Formulation Examples 1 to 3 were respectively produced according to a formulation shown in Table 6 (unit/part by mass).

A content of fats or oils (cocoa butter) in a cocoa powder used was about 11 mass %, and a content of fats or oils in the chocolate was 31.65 mass %.

The produced chocolate was poured into a mold at a temperature at which fats or oils were melting (50° C.), and was cooled and solidified at 10° C.

TABLE 6

| | Formulation | Formulation | Formulation |
|---|---|---|---|
| | Example 1 | Example 2 | Example 3 |
| Sugar | 55.0 | 55.0 | 55.0 |
| Cocoa powder | 15.0 | 15.0 | 15.0 |
| Fats and oils A-1 | 28.5 | 27.0 | 21.0 |
| Fats and oils B | 1.5 | 3.0 | 9.0 |
| Lecithin | 0.2 | 0.2 | 0.2 |
| Vanilla essence | 0.03 | 0.03 | 0.03 |
| Content in fats or oils | | | |
| in chocolate | | | |
| Cocoa butter | 5.2% | 5.2% | 5.2% |
| Fats and oils A-1 | 90.1% | 85.3% | 66.4% |
| Fats and oils B | 4.7% | 9.5% | 28.4% |
| Mass ratio of fats and oils | | | |
| components | | | |
| Fats and oils B/Fats and oils A | 0.052 | 0.111 | 0.428 |

(Evaluation of Bloom Resistance)

The chocolate was allowed to stand overnight at 20° C. and stored in an incubator at a constant temperature of 15° C. to observe change over time. Table 7 summarizes the number of days that had passed from the start of the test until occurrence of bloom.

TABLE 7

| | Fats and oils | Fats and oils | Fats and oils | Fats and oils | Fats and oils |
|---|---|---|---|---|---|
| | B-1 | B-2 | B-3 | B-4 | B-5 |
| Formulation Example 1 | 270 | 270 | 180 | 270 | 270 |
| Formulation Example 2 | 450 | 360 | 180 | 270 | 270 |
| Formulation Example 3 | 450 or more | 450 or more | 180 | 270 | 270 |

(Melting Sensation in Mouth)

After the cooling and solidifying, the cooled and solidified chocolate was aged at 20° C. for 1 week. Thereafter, it was tasted and evaluated in comparison with the chocolate of Comparative Example 1 according to the following criteria. The results are summarized in Table 8.

⊚): The same level as that of Comparative Example 1.

◯: Slightly inferior to Comparative Example 1.

Δ: A melting sensation in the mouth was within a permissible range, but was inferior to the chocolate food products produced using the fats and oils B-1 and the fats and oils B-2.

x: A melting sensation in the mouth was poor.

(Solidification Time)

After the chocolate was completely melted, a temperature was adjusted to 50° C., and a time until it was solidified at room temperature (22° C.) was evaluated in comparison with the chocolate of Comparative Example 1 according to the following criteria. The results are summarized in Table 8.

⊚): The same level as that of Comparative Example 1.

◯: Slightly inferior to Comparative Example 1.

Δ: A solidification time was within a permissible range, but was inferior to the chocolate food products produced using the fats and oils B-1 and the fats and oils B-2.

x: Inferior to Comparative Example 1.

TABLE 8

| | Fats and oils B-1 | | Fats and oils B-2 | | Fats and oils B-3 | | Fats and oils B-4 | | Fats and oils B-5 | |
|---|---|---|---|---|---|---|---|---|---|---|
| | Solidifi- | Melting | Solidifi- | Melting | | Melting | | Melting | | Melting |
| | cation | sensation in | cation | sensation in | Solidification | sensation in | Solidification | sensation in | Solidification | sensation in |
| | time | mouth | time | mouth | time | mouth | time | mouth | time | mouth |
| Formulation | ○ | ⊚ | ○ | ⊚ | ○ | ○ | ○ | ⊚ | ○ | ⊚ |
| Example 1 | | | | | | | | | | |
| Formulation | ○ | ⊚ | ○ | ⊚ | ○ | x | ○ | Δ | Δ | ⊚ |
| Example 2 | | | | | | | | | | |
| Formulation | ○ | ⊚ | ○ | ⊚ | ⊚ | x | ○ | A | Δ | ⊚ |
| Example 3 | | | | | | | | | | |

### (Conclusions) Comprehensive Evaluation

Bloom resistance of the chocolate food product produced using the fats and oils B-1 was favorable. A melting sensation in the mouth and solidification thereof were the same levels as those of Comparative Example 1, and excellent results were obtained.
Bloom resistance of the chocolate food product produced using the fats and oils B-2 was favorable. A melting sensation in the mouth and solidification thereof were the same levels as those of Comparative Example 1, and excellent results were obtained.
Bloom resistance of the chocolate food product produced using the fats and oils B-3 was not improved.
Bloom resistance and solidification of the chocolate food product produced using the fats and oils B-4 were favorable. The result in which a melting sensation in the mouth was within a permissible range, but was inferior to the chocolate food products produced using the fats and oils B-1 and the fats and oils B-2 was obtained.
Bloom resistance and a melting sensation in the mouth of the chocolate food product produced using the fats and oils B-5 were favorable. The result in which solidification was within a permissible range, but was inferior to the chocolate food products produced using the fats and oils B-1 and the fats and oils B-2 was obtained.

Using the fats and oils B-1 to the fats and oils B-5 which were produced above for the fats and oils B, chocolates of Formulation Examples 4 to 7 were respectively produced according to a formulation shown in Table 9 (unit/part by mass).

A content of fats or oils (cocoa butter) in a cocoa powder used was about 11 mass %, and a content of fats or oils in the chocolate was 31.65 mass %.

The produced chocolate was poured into a mold at a temperature at which fats or oils were melting (50° C.), and was cooled and solidified at 10° C.

TABLE 9

| | Formulation | Formulation | Formulation | Formulation |
|---|---|---|---|---|
| | Example 4 | Example 5 | Example 6 | Example 7 |
| Sugar | 55.0 | 55.0 | 55.0 | 55.0 |
| Cocoa powder | 15.0 | 15.0 | 15.0 | 15.0 |
| Fats and oils A-1 | 28.0 | 26.5 | 25.5 | 20.5 |
| Fats and oils B | 1.5 | 3.0 | 3.0 | 9.0 |
| Fats and oils C-1 | 0.5 | 0.5 | 1.5 | 0.5 |
| Lecithin | 0.2 | 0.2 | 0.2 | 0.2 |
| Vanilla essence | 0.03 | 0.03 | 0.03 | 0.03 |
| Content in fats or oils in chocolate | | | | |
| Cocoa butter | 5.2% | 5.2% | 5.2% | 5.2% |
| Fats and oils A-1 | 88.5% | 83.7% | 80.6% | 64.8% |
| Fats and oils B | 4.7% | 9.5% | 9.5% | 28.4% |
| Fats and oils C | 1.6% | 1.6% | 4.7% | 1.6% |
| Mass ratio of fats and oils components | | | | |
| Fats and oils B/Fats and oils A | 0.054 | 0.113 | 0.118 | 0.438 |
| Fats and oils C/Fats and oils B | 0.33 | 0.17 | 0.5 | 0.06 |

(Evaluation of Bloom Resistance)

The cooled and solidified chocolate was allowed to stand overnight at 20° C. and then stored in an incubator at a constant temperature of 15° C. to observe change over time. Table 10 summarizes the number of days that had passed from the start of the test until occurrence of bloom.

TABLE 10

| | Fats and oils | Fats and oils | Fats and oils | Fats and oils | Fats and oils |
|---|---|---|---|---|---|
| | B-1 | B-2 | B-3 | B-4 | B-5 |
| Formulation Example 4 | 270 | 270 | 180 | 270 | 270 |
| Formulation Example 5 | 450 | 360 | 180 | 270 | 270 |
| Formulation Example 6 | 450 | 360 | 180 | 270 | 270 |
| Formulation Example 7 | 450 or more | 450 or more | 180 | 270 | 270 |

(Melting Sensation in Mouth)

After the cooling and solidifying, the cooled and solidified chocolate was aged at 20° C. for 1 week. Thereafter, it was tasted and evaluated in comparison with the chocolate of Comparative Example 1 according to the following criteria. The results are summarized in Table 8.

⊚: The same level as that of Comparative Example 1.

◯: Slightly inferior to Comparative Example 1.

Δ: A melting sensation in the mouth was within a permissible range, but was inferior to the chocolate food products produced using the fats and oils B-1 and the fats and oils B-2.

X: A melting sensation in the mouth was poor.

(Solidification Time)

After the chocolate was completely melted, a temperature was adjusted to 50° C., and a time until it was solidified at room temperature (22° C.) was evaluated in comparison with the chocolate of Comparative Example 1 according to the following criteria. The results are summarized in Table 8.

⊚: The same level as that of Comparative Example 1.

◯: Slightly inferior to Comparative Example 1.

Δ: A solidification time was within a permissible range, but was inferior to the chocolate food products produced using the fats and oils B-1 and the fats and oils B-2.

X: Inferior to Comparative Example 1.

TABLE 11

| | Fats and oils B-1 | | Fats and oils B-2 | | Fats and oils B-3 | | Fats and oils B-4 | | Fats and oils B-5 | |
|---|---|---|---|---|---|---|---|---|---|---|
| | Solidifi- | Melting | Solidifi- | Melting | | Melting | | Melting | | Melting |
| | cation | sensation in | cation | sensation in | Solidification | sensation in | Solidification | sensation in | Solidification | sensation in |
| | time | mouth | time | mouth | time | mouth | time | mouth | time | mouth |
| Formulation | ⊚ | ⊚ | ⊚ | ⊚ | ⊚ | ○ | ⊚ | ○ | ○ | ⊚ |
| Example 4 | | | | | | | | | | |
| Formulation | ⊚ | ⊚ | ⊚ | ⊚ | ⊚ | x | ⊚ | Δ | Δ | ⊚ |
| Example 5 | | | | | | | | | | |
| Formulation | ⊚ | ○ | ⊚ | ○ | ⊚ | x | ⊚ | Δ | ○ | ○ |
| Example 6 | | | | | | | | | | |
| Formulation | ⊚ | ⊚ | ⊚ | ⊚ | ⊚ | x | ⊚ | Δ | Δ | ⊚ |
| Example 7 | | | | | | | | | | |

### (Conclusions) Comprehensive Evaluation

Bloom resistance of the chocolate food product produced using the fats and oils B-1 was favorable. A melting sensation in the mouth and solidification thereof were the same levels as those of Comparative Example 1 and were thought to be within a permissible range, and overall excellent results were obtained.
Bloom resistance of the chocolate food product produced using the fats and oils B-2 was favorable. A melting sensation in the mouth and solidification thereof were the same levels as those of Comparative Example 1 and were thought to be within a permissible range, and overall excellent results were obtained.
Bloom resistance of the chocolate food product produced using the fats and oils B-3 was not improved.
Bloom resistance and solidification of the chocolate food product produced using the fats and oils B-4 were favorable. The result in which a melting sensation in the mouth was within a permissible range, but was inferior to the chocolate food products produced using the fats and oils B-1 and the fats and oils B-2 was obtained.
Bloom resistance and a melting sensation in the mouth of the chocolate food product produced using the fats and oils B-5 were favorable. The result in which solidification was within a permissible range, but was inferior to the chocolate food products produced using the fats and oils B-1 and the fats and oils B-2 was obtained.

### INDUSTRIAL APPLICABILITY

According to the present invention, it is possible to provide a chocolate-like food having favorable texture, flavor, and bloom resistance by blending cocoa butter into non-tempered type chocolate containing laurin-based hard butter.

1. A laurin-based hard butter composition, comprising:
40 to 97 mass % of fats and oils A; and
3 to 60 mass % of fats and oils B,
wherein a mass ratio of the fats and oils B to the fats and oils A (fats and oils B/fats and oils A) is 0.03 to 0.6, and
the fats and oils A and the fats and oils B are the following fats or oils,
the fats and oils A are non-transesterified laurin-based fats and oils that satisfy the following conditions:
a content of lauric acid in a constituent fatty acids composition is 40 to 60 mass %,
a content of saturated fatty acids having 6 to 10 carbon atoms in the constituent fatty acids composition is 1 to 10 mass %,
a content of saturated fatty acids having 16 to 18 carbon atoms in the constituent fatty acids composition is 10 to 40 mass %,
a content of unsaturated fatty acids having 18 carbon atoms in the constituent fatty acids composition is 0.2 to 10 mass %, and
a rising melting point is 30° C. to 40° C., and
the fats and oils B are random transesterified fats and oils that satisfy the following conditions:
a content of saturated fatty acids having 6 to 14 carbon atoms in a constituent fatty acids composition is 20 to 80 mass %,
a content of saturated fatty acids having 16 to 18 carbon atoms in the constituent fatty acids composition is 15 to 60 mass %, and
a total amount of saturated fatty acids having 6 to 10 carbon atoms and unsaturated fatty acids having 18 carbon atoms in the constituent fatty acids composition is 3 to 50 mass %.

2. The laurin-based hard butter composition according to claim 1, further comprising:
0.5 to 10 mass % of fats and oils C,
wherein a mass ratio of the fats and oils C to the fats and oils B (fats and oils C/fats and oils B) is 0.03 to 0.6, and
the fats and oils C are fats and oils satisfying the following condition:
a content of saturated fatty acids having 16 to 22 carbon atoms in a constituent fatty acids composition is 95 mass % or more.

3. The laurin-based hard butter composition according to claim 1,
wherein the fats and oils C are fats and oils satisfying the following conditions:
a content of saturated fatty acids having 16 to 18 carbon atoms in a constituent fatty acids composition is 95 mass % or more,
a content of saturated fatty acids having 16 carbon atoms in the constituent fatty acids composition is 20 to 80 mass %, and
a content of saturated fatty acids having 18 carbon atoms in the constituent fatty acids composition is 20 to 80 mass %.

4. The laurin-based hard butter composition according to claim 1,
wherein the fats and oils A are fats and oils satisfying the following condition:
a content of trans fatty acids in a constituent fatty acids composition is 1 mass % or less.

5. A chocolate-like food comprising, in fats or oils contained in chocolate:
80 to 97 mass % of the laurin-based hard butter composition according to claim 1; and
3 to 20 mass % of cocoa butter.

6. A method of increasing bloom resistance of a chocolate-like food containing 3 to 20 mass % of cocoa butter, comprising blending 80 to 97 mass % of the laurin-based hard butter composition according to claim 1 into fats or oils contained in chocolate.
